(19) United States
(12) Patent Application Publication
(10) Pub. No.: US 2008/0034075 A1
(43) Pub. Date: Feb. 7, 2008

(54) Customer configuration of cellular communications device

(75) Inventors: Kelly Samuel Luinstra, Sammamish, WA (US); David Edwin Chapman, Round Rock, TX (US); Hitesh J. Shah, Seattle, WA (US); Balasubramaniam Kulasekaran Thandu, Cedar Park, TX (US)

Correspondence Address: WOODCOCK WASHBURN LLP, CIRA CENTRE 12th Floor, 2929 ARCH STREET, PHILADELPHIA, PA, 19104-2891, US

(73) Assignee: Cingular Wireless II, LLC, Atlanta, GA (US)

(21) Appl. No.: 11/498,209

(22) Filed: Aug. 1, 2006

(51) Int. Cl. G06F 15/173

(52) U.S. Cl. 709/223

(57) ABSTRACT

Systems and methods are provided for offering customer configuration options when selling a cellular communications device. Offering to sell a cellular communications device can be done over the internet or via an in-store kiosk. The customer can configure at least one software configurable feature at the time of purchase, and the phone is delivered with the software preconfigured according to the customer's specification. Alternatively, the customer indicates one or more internal, non removable selections for the desired features of the phone, and the phone is assembled according to the customer's configuration.

### BACKGROUND

Presently, customers have only limited choice in the features of a cellular telephone. For example, customers can choose external features such as color, faceplates, and insurance options, and some removable features such whether to purchase an extended life battery. However, the great majority of cellular telephone features are dictated by a selected cellular telephone model. Thus, for example, if a customer wishes to buy a MOTOROLA® V195, he or she will get the following features:
Integrated Class 1 Bluetooth wireless technology—eXtended Range wireless technology
Superior talk and standby times with a 1020 mAh battery
GSM dual quadband, 850/900/1800/1900, GPRS Class 10 capability
Lightweight weighing only 100.50 grams
Large internal 128×160 CSTN display
High quality metal-like and soft touch finish
SCREEN3 technology for zero click access to sports, news, entertainment and more¹
A variety of messaging options including MMS, SMS, EMS 5.0 and Wireless Village Instant Messenger¹
Charge your phone and sync to your PC via mini-USB
Push-to-Talk over cellular (PoC)¹
Approximately 10 MB of User Memory Space
22 kHz polyphonic speaker with 24 channels
WAP 2.0 (WSP/HTTP 1.1, WTCP/IP, xHTML Mobile Profile, WCSS, Cookies, WTLS class 2, TLS 1.0/SSL 3.0)

The customer does not have any opportunity to deselect features from the above list. For example, the customer has no choice but to pay the cost associated with the large internal 128×160 CSTN display, even if that feature is not particularly important to the customer. Similarly, if there are features that the customer desires but are not included in the phone's feature set, for example a 3 mega pixel digital camera, the customer does not have any opportunity to include such additional features. The customer must find another phone model that most closely approximates his or her desired feature set.

Furthermore, the customer presently has no opportunity to request further configuration of the software configurable features of a phone. Software configuration is done by the customer after purchasing the phone. For example, if the customer wishes to load music, games, photographs, videos, contact information, and so forth onto the phone, he or she must utilize appropriate hardware and or software to do so him or herself. Such hardware and software may or may not ship with the phone.

There is a need in the industry to provide customers with additional freedom in the hardware and software configurations of cellular telephones at the time of purchase.

### SUMMARY

In consideration of the above-identified shortcomings of the art, the present invention provides systems and methods for customer configuration of a cellular telephone at the time of purchase.

In a first embodiment, a method is provided for selling a cellular communications device, comprising offering to sell a cellular communications device comprising at least one software configurable feature, said software configurable feature comprising a contacts list, offering a plurality of selectable options for said at least one software configurable feature, receiving a selection of at least one of said selectable options, and causing said at least one software configurable feature to be configured according to said selection.

In another aspect, the at least one software configurable feature further comprises a wallpaper.

In another aspect, the at least one software configurable feature further comprises a ring tone.

In another aspect, the at least one software configurable feature further comprises a game.

In another aspect, the at least one software configurable feature further comprises a music repository.

In another aspect, the cellular communications device comprises a cellular telephone.

In another aspect, the offering to sell a cellular communications device, offering a plurality of selectable options, and receiving a selection are conducted via a website.

In another aspect, the offering to sell a cellular communications device, offering a plurality of selectable options, and receiving a selection are conducted via in-store kiosk

In another aspect, the method further comprises offering tutorial for said at least one software configurable feature.

In another aspect, the method further comprises indicating a price for at least one software configurable feature.

In another aspect, the method further comprises storing data that associates said customer and with said selection.

In another aspect, the method further comprises providing a mechanism to further configure said at least one software configurable feature.

In a next embodiment, a method is provided for selling a cellular communications device, comprising offering to sell a cellular communications device, receiving customer configuration data for software on said cellular communications device, wherein said at customer configuration data comprises a contacts list; and causing said software to be configured according to said customer configuration data.

In another aspect, the customer configuration data comprises a wallpaper.

In another aspect, the customer configuration data comprises a ring tone.

In another aspect, the customer configuration data comprises a music repository.

In another aspect, the cellular communications device comprises a cellular telephone.

In another aspect, the offering to sell a cellular communications device and receiving customer configuration data are conducted via a website.

In another aspect, the method further comprises storing data that associates said customer and with said customer configuration data.

In another aspect, the method further comprises providing data and at least one mechanism to configure said data to a customer.

In a next embodiment, a method is provided for selling a cellular communications device, comprising offering to sell a cellular communications device, offering a plurality of selectable internal non-removable features for said cellular communications device, said plurality of selectable internal non-removable features comprising a camera, wherein a plurality of camera resolutions may be selected for said camera receiving a selection of at least one of said internal non-removable features, causing said at least one internal non-removable feature to be installed on said cellular communications device, and causing said cellular communications device to be delivered to a customer.

In another aspect, the at least one internal non-removable feature comprises a display.

In another aspect, the at least one internal non-removable feature comprises a digital music player.

In another aspect, the at least one internal non-removable feature comprises a speakerphone.

In another aspect, the at least one internal non-removable feature comprises support for a communication protocol.

In another aspect, the at least one internal non-removable feature comprises a software feature.

In another aspect, the cellular communications device comprises a cellular telephone.

In another aspect, the offering to sell a cellular communications device, offering a plurality of selectable features, and receiving a selection are conducted via a website.

In another aspect, the method further comprises storing data that associates said customer and with said selection.

Other advantages and features of the invention are described below.

### BRIEF DESCRIPTION OF THE DRAWINGS

The systems and methods for customer customization of a mobile device specification in accordance with the present invention are further described with reference to the accompanying drawings in which:

FIG. 1 illustrates an exemplary display for offering to sell a cellular communications device;

FIG. 2 illustrates offering a plurality of selectable options for a contacts list and also a box where a customer can identify a file to upload contact list customer configuration data;

FIG. 3 illustrates offering a plurality of selectable options for ring tones and also a box where a customer can identify a file to upload ring tone customer configuration data;

FIG. 4 illustrates offering a plurality of selectable options for wallpaper and also a box where a customer can identify a file to upload wallpaper customer configuration data;

FIG. 5 illustrates a box where a customer can identify a file to upload any customer configuration data;

FIG. 6 illustrates offering a plurality of selectable options for a music repository and also a box where a customer can identify songs to upload song customer configuration data;

FIG. 7 illustrates offering a plurality of selectable options for games and also a box where a customer can identify a game to upload game customer configuration data;

FIG. 8 illustrates a display whereby a customer can further configure customer configuration data;

FIG. 9 illustrates offering a plurality of selectable options for a customer preconfigured device and also a box where a customer can identify a customer preconfiguration to upload to the seller;

FIG. 10 illustrates offering an opportunity to view the customer configured device and select external and removable features;

FIG. 11 illustrates a system with a seller server and a client computer for practicing the invention using a network such as the internet;

FIG. 12 illustrates an in-store kiosk whereby the invention may be practiced when a customer interacts with the kiosk via an input device.

### DETAILED DESCRIPTION

Certain specific details are set forth in the following description and figures to provide a thorough understanding of various embodiments of the invention. Certain well-known details often associated with computing and software technology are not set forth in the following disclosure, however, to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention.

In a first embodiment, a method is provided for selling a cellular communications device. An example of a cellular communications device is a cellular telephone (cell phone), as that term is widely understood by the consuming public. The cell phone has recently undergone a massive proliferation in the United States and across the world. The variety of cell phones have also widened to suit people's diverse needs. Cell phones may be in a wide number of form factors such as the classic candy bar shape, the clamshell, the slider, and the Personal Digital Assistant (PDA). Cell phones are cellular communications devices that are highly portable by virtue of their light weights and small size—usually small and light enough to be carried in a pocket. Cellular communications devices comprise cell phones as well as any other electronic devices capable of wireless communication over cell networks.

Selling refers to offering to exchange an item in return for payment of money or other consideration. Selling could be for cash, charged to a credit or debit card, electronic funds transfer, and so forth. In preferred embodiments, selling may be computer assisted, such as by offering a device for sale on the internet via a web page, or offering a device via an in-store kiosk that is accessible inside a cell phone store. In such embodiments, the user may view images, text, and video relating to the sale on a display, and interact with the display via an input device such as a mouse, keyboard, or touchpad. To complete a transaction, the user may enter credit card or other payment information, or if at a in-store kiosk, he may indicate that the transaction can be completed by a clerk in the store.

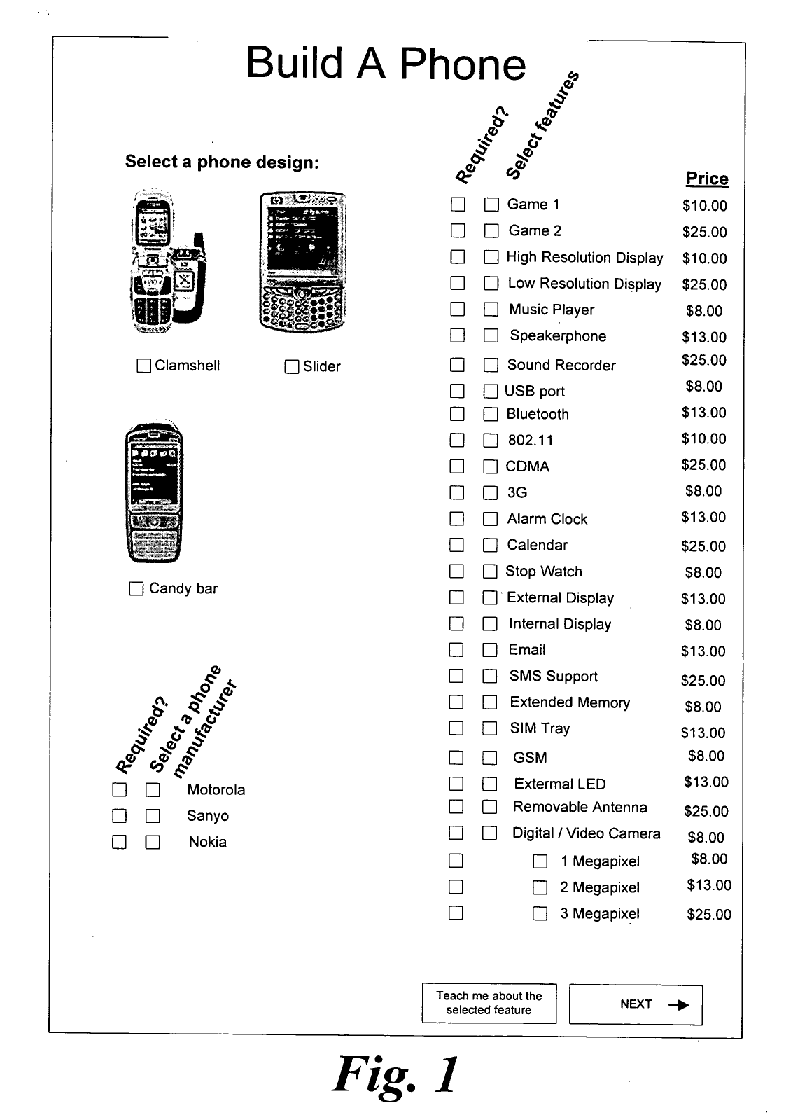

An exemplary display for offering to sell a cellular communications device is presented in FIG. 1. In FIG. 1, a number of check boxes are provided whereby a user can select phone design, manufacturer, and any number of features to be included in the selected phone. The features may be listed along with a price, as illustrated. A “Next” button may be provided which will take the user to another display allowing selection of further options as will be discussed with reference to subsequent figures. A final display may request credit card or other payment information, allowing for completion of the transaction.

FIG. 1 illustrates a wide variety of features that may be selected for a cell phone. The user may select a checkbox next to a feature to indicate he wishes to include that feature in his cell phone. Because some features may be incompatible in a selected phone design, the user may further indicate which of the features are required by selecting the “required” check box. If incompatible, features that are not required may be removed from the user's selections. If the user's required features are impossible to combine, the user may be directed to an informational screen indicating which features are incompatible and requesting deletion or modification of feature selections. Alternatively, selection of a feature that is incompatible with other features may automatically disable the opportunity to select incompatible features.

Also, some features may be linked such that purchase of one feature requires inclusion of another feature. Information can be presented to educate the user as necessary. For example, in one embodiment, selection of a phone design and manufacturer may automatically cause selection of required features for that phone, and disable the opportunity to select any features that are incompatible with that phone.

The selectable features displayed in the right hand column of FIG. 1 are generally either software configurable features or internal non-removable features. “Internal” as that term is used means inside the exterior casing of a device. Non-removable means that the feature is not intended to be removed by the end user, and as such is not configured with the intent of facilitating easy removal and replacement. Internal, non-removable features may comprise hardware features, software features, and features that comprise both hardware and software functionality. It should be noted that features that may be internal and non-removable in one phone design may be external and/or removable in another phone design. Thus, features cannot be readily identified as always internal or always non-removable, and the analysis must proceed based on whether the feature is internal and non-removable for a particular phone in question.

Many exemplary features that are frequently internal and non-removable in many phone designs are listed in FIG. 1. Thus a high resolution display, a low resolution display, a music player, a speakerphone, a sound recorder, a Universal Serial Bus (USB) port, Bluetooth® support, 802.11 support, Code Division Multiple Access (CDMA) support, Third Generation Wireless 3G support, an alarm clock, a calendar, stop watch, an external display, an internal display, email support, Short Message Service (SMS) support, an extended memory, a Subscriber Identity Module (SIM) port, Global System for Mobile Communications (GSM) support, an external Light Emitting Diode (LED), a removable antenna, a digital camera, and a video camera, either of which may be a specified resolution such as 1, 2, or 3 mega pixels, can be selected in some embodiments.

Once a customer has arrived at the desired features for his cellular communications device, he can proceed with the purchase transaction. A cellular communications device with the selected features may be built for the customer and delivered to the customer, thereby allowing unprecedented flexibility in the feature combinations available to cellular communications device buyers.

The exemplary embodiment in FIG. 1 further comprises a “teach me about this feature” button that can be used to assist customers in determining whether to purchase a desired feature. By selecting one or more features, then depressing this button, the user can be directed to educational information about the selected features.

Games such as “game 1” and “game 2” are more typically removable in that mechanisms may exist for deleted games from a cellular communications device. Games are more typically an example of a software-configurable feature. Most cellular communications devices presently comprise at least one software configurable feature. A software configurable feature is an aspect of a cellular communications device that can be configured by a user of the device via software installed on the device. Typically, though not necessarily, such configuration is done at least in part by navigating through options presented on a display, such as by depressing buttons on the device.

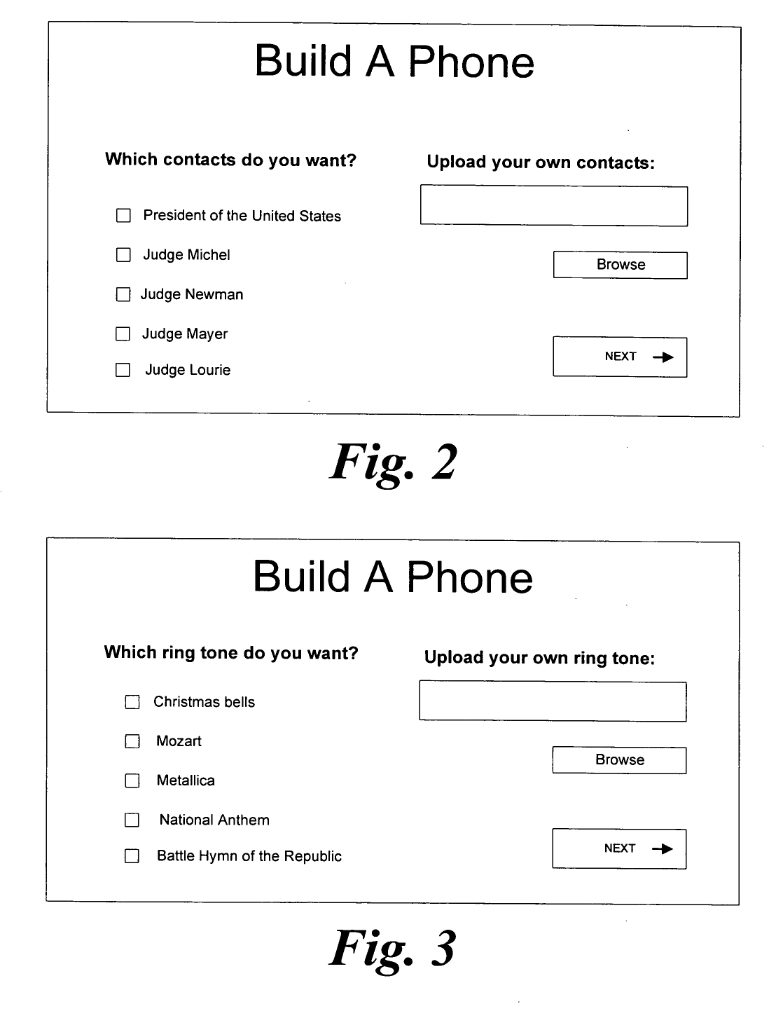

Examples of software configurable features comprise, for example, a user's contacts list, ring tones, wallpapers, music repository, and games. FIGS. 2-7 illustrate exemplary displays that may be used to enable customer configuration of a software configurable feature at a time of sale.

A contacts list is configured by adding or modifying contact names, telephone numbers, and/or other data such as emails, addresses, notes, and so forth. FIG. 2 illustrates offering a plurality of selectable options for a contacts list. The user can, for example, select boxes next to desired contacts such as the President of the United States, Judge Michel, Judge Newman, Judge Mayer, and Judge Lourie. Corresponding contact information will be loaded onto the cellular communications device prior to delivery to the customer. Selectable contact information may be made available based on publicly available information, or based on contact information previously on file for the particular customer, or based on a query for other customers who included the present customer in their own contact information. Once contact information is selected and, for example, the customer hits the “next” button, the selections can be sent to, and received by, the seller's computers, which thereby receive a selection of at least one of said selectable options. The seller then causes said at least one software configurable feature to be configured according to said selection.

Alternatively, the customer can upload his own contact information. In one embodiment, the customer can enter the path to a contacts file, for example, a file stored on his local computer or on disk, in a box under “upload your own contacts,” or can hit the “browse” button and navigate to the desired file, thereby causing the file path to be automatically entered in the box. By selecting “next”, the user may cause the contact information to be sent to the seller's computer, which receives the contacts and loads them onto the customer's phone prior to delivery. Contact information is an example of customer configuration data for software on a cellular communications device. Loading the contacts onto a cellular communications device is an example of causing software to be configured according to said customer configuration data.

FIG. 3 illustrates a display similar to FIG. 2, except the software configurable feature is a ring tone, the plurality of selectable options are various sounds for ring tones, and customer configuration data which a customer may upload is ring tone data, for example a ring tones file on the customers' local computer. Ring tones are the sounds that are made by a device when the device is contacted by another device. Ring tones may be software configurable for example by downloading new ring tones, setting desired ring tones, and setting a volume level for ring tones. Desired ring tone settings may be preconfigured for a user using a system for selling a device such as that presented in FIG. 3.

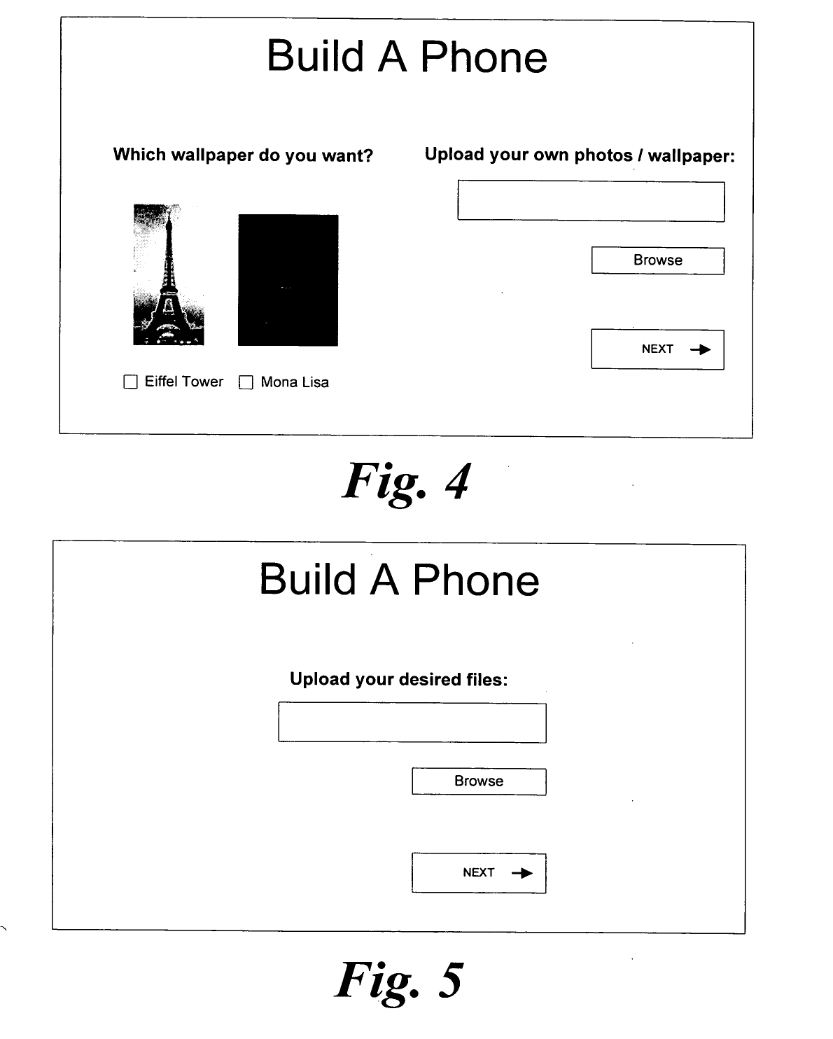

FIG. 4 illustrates a display similar to FIG. 2, except the software configurable feature is a wallpaper, the plurality of selectable options are various images for wallpapers, and customer configuration data which a customer may upload is wallpaper image data, for example a wallpapers file on the customers' local computer. Wallpapers are images displayed in a display background. Wallpapers are configurable for example by downloading or otherwise obtaining desired wallpaper images, and setting an image as a wallpaper. Desired wallpaper settings may be preconfigured for a user using a system for selling a device such as that presented in FIG. 4.

FIG. 5 illustrates a display similar to FIG. 2, except the software configurable feature is a device memory capable of storing files, the plurality of selectable options, in this embodiment, are not presented, and customer configuration data which a customer may upload is customer files bearing content of the customer's choosing. For example any files the customer wishes to upload from a disk or from their local computer. Desired files settings may be placed on a device for a user at the time of purchase using a system for selling a device such as that presented in FIG. 5.

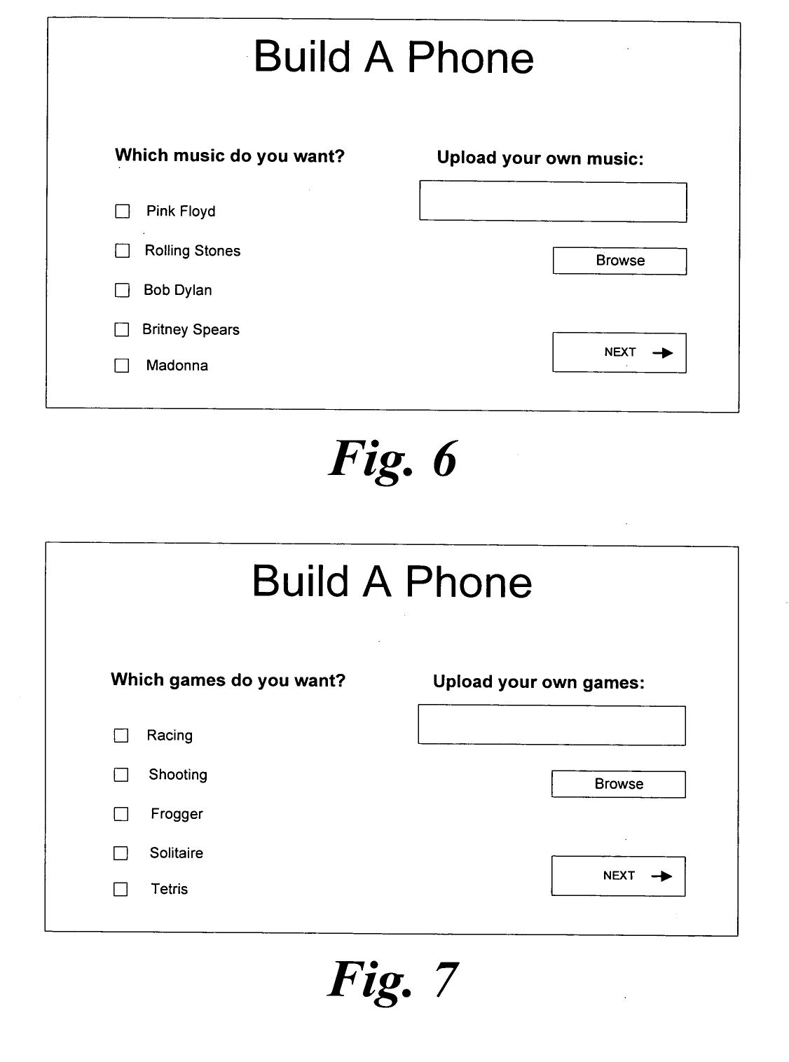

FIG. 6 illustrates a display similar to FIG. 2, except the software configurable feature is a music repository, the plurality of selectable options are various songs, and customer configuration data which a customer may upload is song files, for example songs from the customers' local computer, disk inserted into an in-store kiosk, or the like. A music repository comprises a digital memory onto which digital song files can be recorded. Many cell phones presently have storage that may be used for songs, or for that matter video files and/or other digital files. A music repository is thus a subset of user files more generally as discussed with reference to FIG. 5. A music repository can be configured by loading new songs onto a device, categorizing files, naming files, and the like. Desired music repository settings may be preconfigured for a user using a system for selling a device such as that presented in FIG. 6.

FIG. 7 illustrates a display similar to FIG. 2, except the software configurable feature is a game, the plurality of selectable options are various games, and customer configuration data which a customer may upload is game files. Games are generally video games that involve user interaction with displayed game content. Games can be configured by loading new games, configuring game settings, setting up player information, loading player privileges and/or restrictions, configuring desired control modes, and the like. Desired game settings may be preconfigured for a user using a system for selling a device such as that presented in FIG. 7.

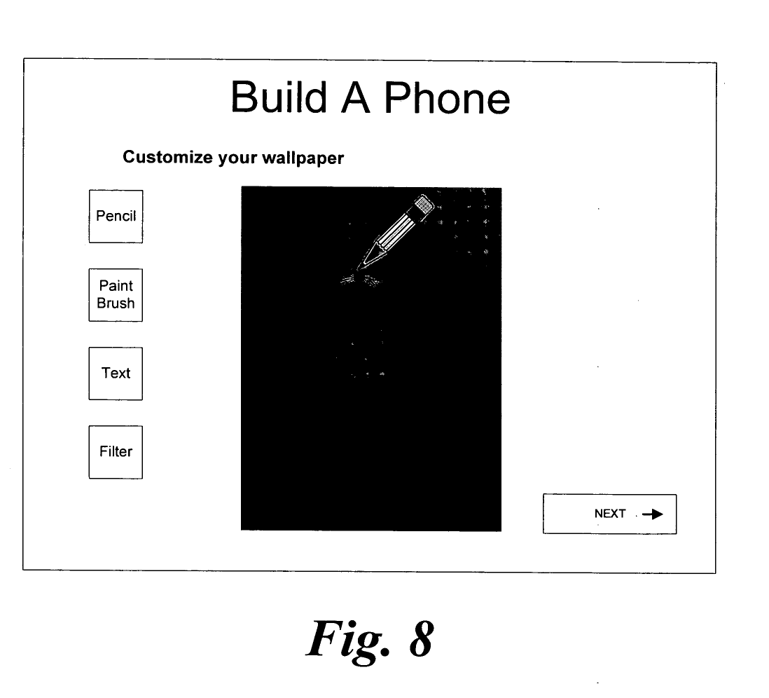

FIG. 8 illustrates a display that allows further configuration of a software configurable feature. Here, the user interacts with an image editing program to edit an image that will be used as a wallpaper. Tools for further configuring the wallpaper such as “pencil,” “paint brush,” “text,” and “filter” are provided. Further configuration of other software configurable features might include, for example, selecting additional settings for games, songs, files, and the like. The further configurations will be sent to, and received by, the sellers computer and the device is configured accordingly.

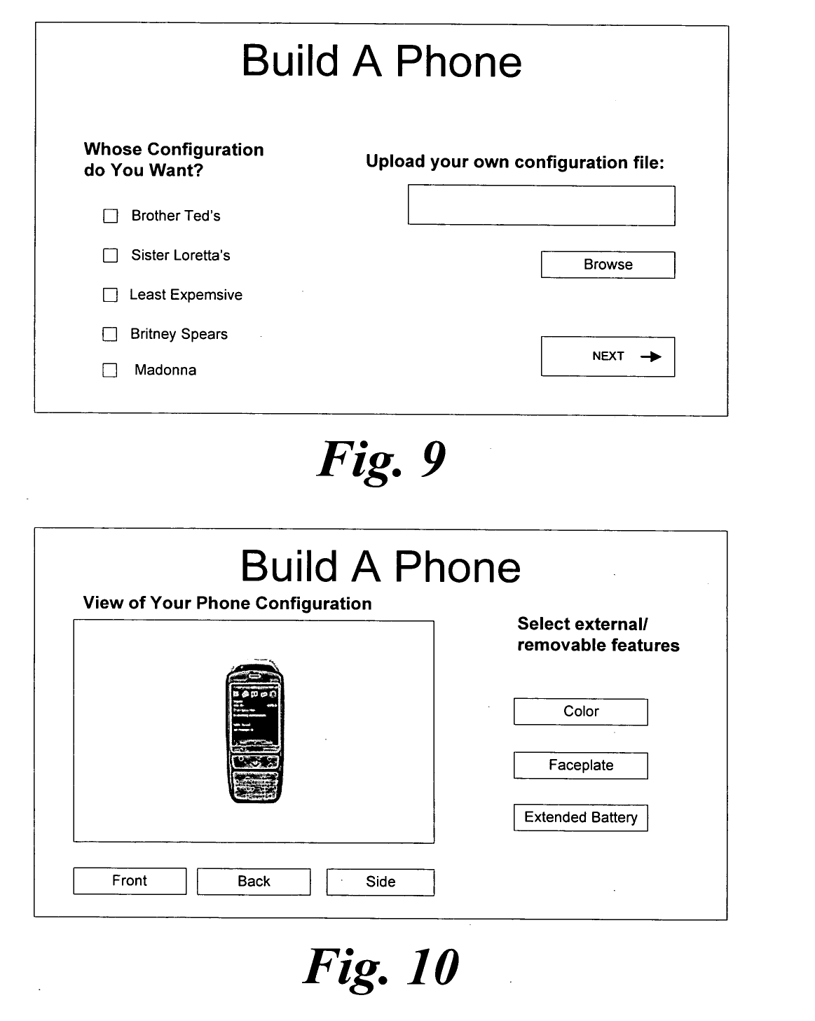

FIG. 9 illustrates another aspect of the invention in which a plurality of selectable device configurations may be presented to the customer. It is contemplated that with the increased freedom in device feature selection that the invention facilitates, customers will see other people's customer-configured devices and like the feature set, and want to have the same feature set for themselves. Thus, the plurality of selectable options in FIG. 9 provide configurations that were used by other customers, such as a customer's brother “Ted,” sister “Loretta,” and famous people such as Madonna and Britney Spears. Other preconfigured options such as “Least Expensive” may also be made available. A device can be built for the customer that is identical to the selected previously configured device. Certain software configurable features, such as the contacts list or personal files of the previous customer, may be excluded from the new customer's device. Finally, in an alternative embodiment a customer can upload a configuration file, such as a file that describes what features the customer wants.

FIG. 10 illustrates a display that can be presented to allow customers to view the device that they have configured, and further select external or removable features such as faceplates, device color, extended battery, and so forth. Buttons such as “Front,” “Back,” and “Side” can show views of the device from a variety of angles. The customer may further be enabled to view the interior of the device, navigate demo software showing the device software as configured by the customer, and so forth.

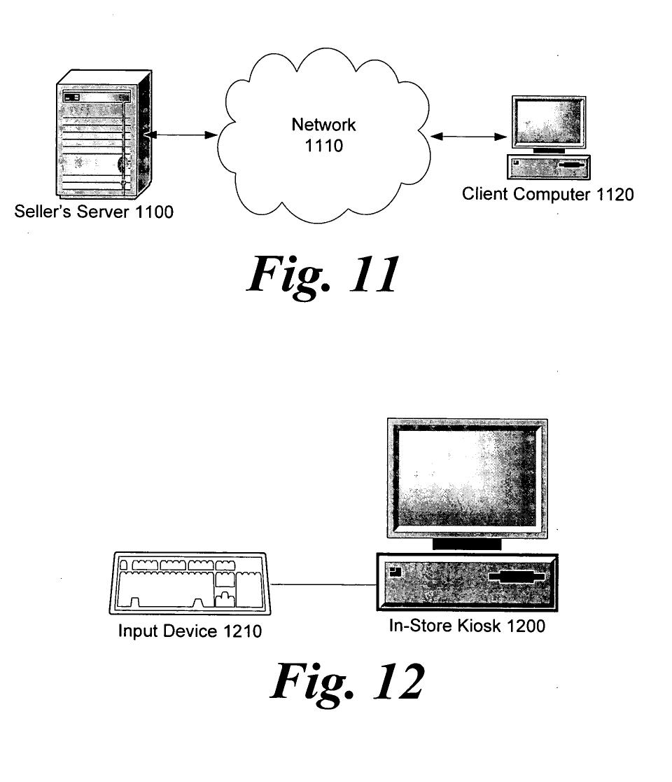

FIG. 11 and FIG. 12 illustrate systems whereby the contemplated techniques and processes associated with aspects of the invention may be implemented. FIG. 11 provides a seller server computer 1100 attached to a network 1110 such as the internet, and a client computer 1120 also attached to the network 1110. Displays such as those presented in FIGS. 1-10 can be maintained on the seller server 1100, and accessed by client computer 1120 to the via network 1110.

In the embodiment of FIG. 11, offering to sell a cellular communications device and offering a plurality of selectable options may be accomplished by maintaining a web page or other such display on the seller server, or on servers maintained by an Internet Service Provider (ISP), but controlled by a seller. Receiving a selection of at least one of said selectable options and/or receiving customer configuration data is accomplished when the customer indicates a selection or uploads a file, and thus information pertaining to the selection or the file is received by the seller, whether by seller server 1100 or otherwise. Causing said at least one software configurable feature to be configured according to said selection is accomplished when the seller subsequently builds a device according to the customer's selections. The seller may build the device themselves, or may send an order to a device manufacturer or assembler, thereby causing a third party to configure the device according to the customer's configuration.

In the embodiment of FIG. 12, an in-store kiosk may be attached to an input device 1210, displayed here as a keyboard but which may also comprise a mouse, touch screen, or other input device. Here, offering to sell a cellular communications device and offering a plurality of selectable options may be accomplished by displaying screens such as those in FIGS. 1-10 on the kiosk 1200 display. Receiving a selection of at least one of said selectable options and/or receiving customer configuration data is accomplished when the customer indicates a selection using the input device 1210 or loads a file from a location such as the internet or a customer-carried memory device, and information pertaining to the selection or configuration data is received at the kiosk 1200 or other seller electronics. Causing said at least one software configurable feature to be configured according to said selection is accomplished when the seller subsequently builds a device according to the customer's selections. Again, the seller may build the device themselves, or may send an order to a device manufacturer or assembler, thereby causing a third party to configure the device according to the customer's configuration.

In addition to the specific implementations explicitly set forth herein, other aspects and implementations will be apparent to those skilled in the art from consideration of the specification disclosed herein. It is intended that the specification and illustrated implementations be considered as examples only, with a true scope and spirit of the following claims.

1. A method for selling a cellular communications device, comprising:
offering to sell a cellular communications device comprising at least one software configurable feature, said software configurable feature comprising a contacts list;
offering a plurality of selectable options for said at least one software configurable feature;
receiving a selection of at least one of said selectable options;
causing said at least one software configurable feature to be configured according to said selection.

2. The method of claim 1, wherein said at least one software configurable feature further comprises a wallpaper.

3. The method of claim 1, wherein said at least one software configurable feature further comprises a ring tone.

4. The method of claim 1, wherein said at least one software configurable feature further comprises a music repository.

5. The method of claim 1, wherein said cellular communications device comprises a cellular telephone.

6. The method of claim 1, wherein said offering to sell a cellular communications device, offering a plurality of selectable options, and receiving a selection are conducted via a website.

7. The method of claim 1, wherein said offering to sell a cellular communications device, offering a plurality of selectable options, and receiving a selection are conducted via in-store kiosk

8. The method of claim 1, further comprising offering tutorial for said at least one software configurable feature.

9. The method of claim 1, further comprising indicating a price for at least one software configurable feature.

10. The method of claim 1, further comprising storing data that associates said customer and with said selection.

11. The method of claim 1, further comprising providing a mechanism to further configure said at least one software configurable feature.

12. A method for selling a cellular communications device, comprising:
offering to sell a cellular communications device;
receiving customer configuration data for software on said cellular communications device, wherein said at customer configuration data comprises a contacts list;
causing said software to be configured according to said customer configuration data.

13. The method of claim 12, wherein said customer configuration data comprises a wallpaper.

14. The method of claim 12, wherein said customer configuration data comprises a ring tone.

15. The method of claim 12, wherein said customer configuration data comprises a music repository.

16. The method of claim 12, wherein said cellular communications device comprises a cellular telephone.

17. The method of claim 12, wherein said offering to sell a cellular communications device and receiving customer configuration data are conducted via a website.

18. The method of claim 12, further comprising storing data that associates said customer and with said customer configuration data.

19. The method of claim 12, further comprising providing data and at least one mechanism to configure said data to a customer.

20. A method for selling a cellular communications device, comprising:
offering to sell a cellular communications device;
offering a plurality of selectable internal non-removable features for said cellular communications device, said plurality of selectable internal non-removable features comprising a camera, wherein a plurality of camera resolutions may be selected for said camera;
receiving a selection of at least one of said internal non-removable features;
causing said at least one internal non-removable feature to be installed on said cellular communications device;
causing said cellular communications device to be delivered to a customer.

21. The method of claim 20, wherein said at least one internal non-removable feature comprises a display.

22. The method of claim 20, wherein said at least one internal non-removable feature comprises a digital music player.

23. The method of claim 20, wherein said at least one internal non-removable feature comprises a speakerphone.

24. The method of claim 20, wherein said at least one internal non-removable feature comprises support for a communication protocol.

25. The method of claim 20, wherein said at least one internal non-removable feature comprises a software feature.

26. The method of claim 20, wherein said cellular communications device comprises a cellular telephone.

27. The method of claim 20, wherein said offering to sell a cellular communications device, offering a plurality of selectable features, and receiving a selection are conducted via a website.

28. The method of claim 20, further comprising storing data that associates said customer and with said selection.
